(19) United States
(12) Patent Application Publication
(10) Pub. No.: US 2004/0224421 A1
(43) Pub. Date: Nov. 11, 2004

(54) Bi-directional scanning method

(76) Inventors: Herman DeWeerd, Bedford, MA (US); Michael Beach, Arlington, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/980,658

(22) PCT Filed: Jun. 15, 2000
(86) PCT No.: PCT/US00/16514

(51) Int. Cl. G01N 21/76

(52) U.S. Cl. 436/172; 422/82.08; 250/458.1; 250/459.1

(57) ABSTRACT

An optical instrument assembly includes a transmitter (12) for emitting an optical signal onto a specimen, a detector (40) for detecting a light emitted from the specimen, a first drive mechanism (50) for varying the position of the signal onto the specimen, and a locator (100) for determining the location of the first drive mechanism relative to the specimen.

### BACKGROUND OF THE INVENTION

The subject invention relates generally to an improved scanner of the type that scans specimens for performing subsequent computer analysis on the specimens.

Micro array biochips are being used by several biotechnology companies for scanning genetic DNA samples applied to biochips into computerized images. These chips have small substrates with thousands of DNA fragments that represent the genetic codes of a variety of living organisms including human, plant, animal, and pathogens. They provide researchers with information regarding the DNA properties of these organisms. Experiments can be conducted with significantly higher throughput than previous technologies offered by using these biochips. Biochip technology is used for genetic expression, DNA sequencing of genes, food and water testing for harmful pathogens, and diagnostic screening. Biochips may be used in pharmacogenomics and proteomics research aimed at high throughput screening for drug discovery.

DNA fragments are extracted from a sample and are tagged with a fluorescent dye having a molecule that, when excited by a laser, will emit light of various colors. These fluorescently tagged DNA fragments are then spread over the chip. A DNA fragment will bind to its complementary (cDNA) fragment at a given array location. A typical biochip is printed with a two-dimensional array of thousands of cDNA fragments, each one unique to a specific gene. Once the biochip is printed, it represents thousands of specimens in an area usually smaller than a postage stamp.

A microscope collects data through a scanning lens by scanning one pixel of a specimen at a time. The scanning lens projects emitted light from the specimen onto a scanner that is manipulated along a predetermined pattern across the chip scanning an entire biochip one pixel at a time. The pixels are relayed to a controller that sequentially connects the pixels to form a complete, computerized biochip image. To accurately connect the pixels and form the biochip image, the controller must determine where the lens is relative to the specimen. Frequently, drive mechanisms that manipulate the scanner do not relay accurate location information to the controller due to slippage of the mechanism's bearings and general wear.

Absent accurate location information, the controller cannot connect the pixels in an accurate sequential manner resulting in a blurred, and sometimes unreadable, computerized biochip image. Therefore, a need exists for a scanning microscope that can accurately determine the location of the scanning mechanism relative to the specimen being scanned.

### SUMMARY OF THE INVENTION AND ADVANTAGES

The present invention provides an optical instrument assembly that scans a DNA specimen one pixel at a time and relays the scan to a controller that connects the pixels forming a computerized biochip image of the specimen. The assembly includes a transmitter for emitting an optical signal and a reflector for directing the optical signal onto the specimen. A detector includes an objective lens that focuses the emitted optical signal from the specimen onto a sensor. The sensor transmits the emitted optical signal to a controller one pixel at a time.

A first drive mechanism varies the position of the optical signal transmitted onto the specimen. A second drive mechanism varies the position of the specimen relative to the optical signal. In this manner, a complete scan of the specimen is performed and transmitted to a controller one pixel at a time. A locator accurately determines the location of the first drive mechanism, and therefore of the scanner, relative to the specimen. The locator relays the location of the first drive mechanism to the controller with each pixel scanned.

By relaying accurate location information to the controller, the problems of blurred and unreadable scans associated with the prior art have been resolved. The location information is used by the controller to improve the sequential connection of the scanned pixels when forming the computerized image of the specimen.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a detailed view of an optical instrument of the present invention;

FIG. 2 is a plan view of a biochip specimen of the present invention showing the movement of the scanning objective lens;

FIG. 3a is a side view of the first drive mechanism showing the preferred embodiment of the locator of the subject invention;

FIG. 3b is a side view of the first drive mechanism showing a first alternative of the locator of the subject invention;

FIG. 3c is a side view of the first drive mechanism showing a second alternative embodiment of the subject invention; and

FIG. 4 is top view of the second drive mechanism.

### DETAILED DESCRIPTION OF THE PREFERRED EMBODIMENT

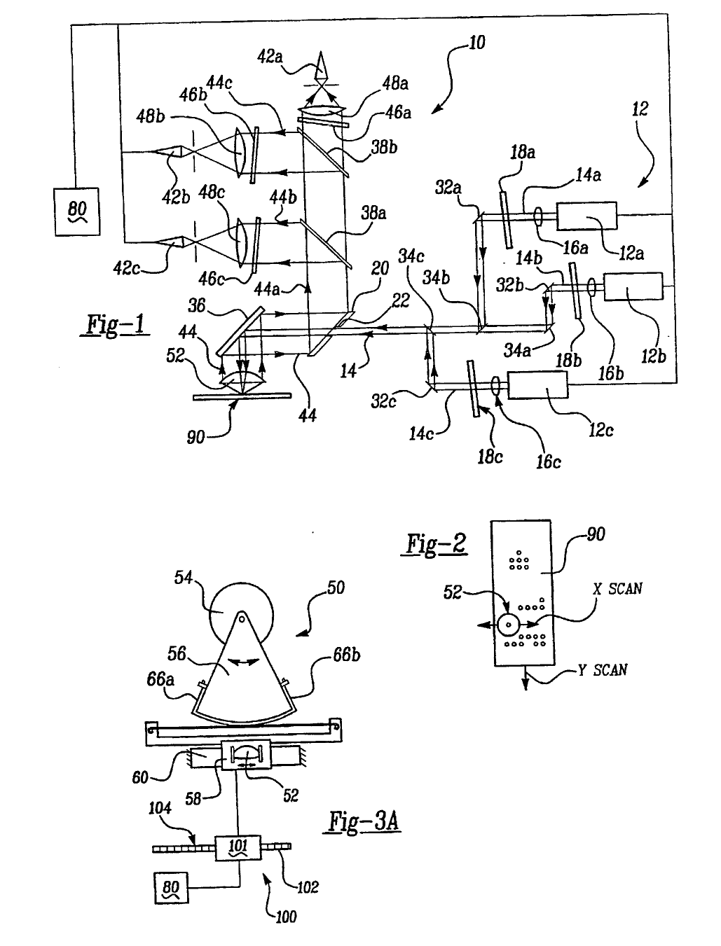

The optical instrument assembly of the present invention is generally shown in FIG. 1 at 10. The assembly includes a transmitter 12 for emitting an optical signal 14. In the preferred embodiment, the transmitter 12 comprises a laser. FIG. 1 shows three transmitters 12a-c, each emitting an optical signal 14a-c having a different wavelength. Additional transmitters 12 may be introduced to the assembly 10 as needed.

A reflector 30 directs the optical signal 14 onto a specimen 90. The reflector 30 includes a plurality of turn mirrors 32. FIG. 1 shows three turn mirrors 32a-c corresponding to the same number of transmitters 12a-c. Each optical signal 14a-c is reflected by the turn mirrors 32a-c into corresponding beam combiners 34a-c. The beam combiners 34a-c, known as dichroic filters transmit light of one wavelength while blocking other wavelengths. The beam combiner 34a-c collect the individual optical signals 14a-c into a combined beam along a single path and direct the beam towards a beam splitting mirror 20. The beam splitting mirror 20 includes an opening 22 through which the combined optical signals 14a-c travel. Subsequently, the combined optical signals 14a-c reflect off a ninety degree fold mirror 36 located immediately above a scanning objective lens 52, which focuses the combined optical signals 14a-c onto a section of the specimen 90 in a forward and reverse direction. A first drive mechanism 50 varies the position of the combined optical signal 14a-c on the specimen 90 as will be explained further herein below.

The specimen 90 is treated with dyes having fluorescent properties when subjected to the optical signal 14a-c. The specimen 90, having been treated with the dye, and illuminated with the optical signal 14, emits the optical signal 44 at a wavelength corresponding to the dye selected. Different dyes may be used to examine different specimen properties. Multiple dyes may be used to examine different properties of the same specimen 90 simultaneously.

The assembly 10 includes a detector 40 with a sensor 42 for detecting a emitted optical signal 44 from the specimen 90. The emitted optical signal 44 reflects off the opposite side of the beam splitting mirror 20 through a plurality of beam splitters 38a-b to separate the emitted optical signal 44 into individual signals 44a-c corresponding to different dyes. Each individual signal passes though an emission filter 46a-c and is focused by a detector lens 48a-c into a pinhole. The individual signals 44a-c proceed through the pinhole to contact the individual sensors 42a-c. The sensors 42a-c are in communication with a controller 80, the purpose of which will be described in further detail hereinbelow.

As shown in FIG. 2, the objective lens 52 is moved in forward and reverse directions along the x-axis of the specimen 90 collecting data in each direction. The specimen 90 does not move in the x direction. The specimen 90 is moved in the y direction incrementally each time a scan is about to be started in the x direction. In this manner, a rectangular zigzag scanning pattern is performed upon the specimen 90.

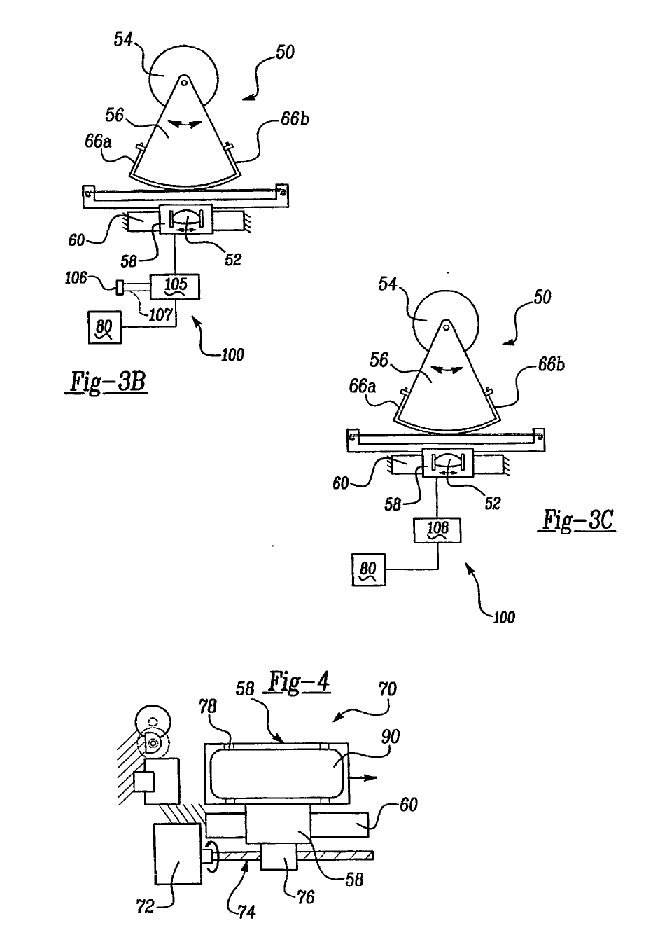

FIGS. 3a-c show a first drive mechanism 50 for varying the position of the combined optical signal 14a-c on the specimen 90. The first drive mechanism 50 preferably employs a galvanometric torque motor 54 to rotate a sector-shaped cam 56 over an angle between plus forty degrees and negative forty degrees. The circular portion of the cam 56 is connected to the carriage 58 via a set of roll-up, roll-off thin, high strength steel wires 66a-b. The scanning objective lens 52 is attached to the carriage 54. The radius of the cam 56 is such that its rotation will cause the carriage 58 to travel a linear distance along a rail 60 commensurate with the length of the scan along the x-axis.

FIG. 4 shows a second drive mechanism 70 employing a stepper motor 72 to drive a precision screw 74 in a known manner. A nut 76 on the screw 74 is attached to the carriage 58 so that any rotation of the screw 74 will cause the carriage 58 to move along a linear rail 60. The carriage in turn is equipped with a tray 76 which includes retainers 78 to hold a specimen 90 slide in a position and orientation that is repeatable within an accuracy required by optical focus and alignment criteria. The rail 60 and the stepper motor 72 are attached to the frame of the second drive mechanism 70.

The first and second drive mechanisms 50, 70 transmit location information to the controller 80. The controller 80 uses the location information to map the scan data received from the sensors 42a-c. A scanning accuracy of one micron is required to accurately map the scan using data from both directions scanned on the x-axis. However, mechanical couplings of the drive mechanisms tend to slip with increasing frequency as the assembly 10 ages. Therefore, it becomes increasingly difficult to match the scans in the forward and reverse directions resulting in inaccurate or blurred pixels being transmitted to and correlated by the controller 80.

Referring again to FIG. 3a, a locator 100 is affixed to the first drive mechanism 50 for determining the location of the first drive mechanism 50 relative to the specimen 90. In the preferred embodiment, the locator 100 takes the form of an encoder. The encoder provides a precise location of the first drive mechanism 50, and therefore of the scanning objective lens 52 relative to the specimen 90 meeting the accuracy requirement of one micron. By establishing and transmitting the precise location of the objective lens 52 during the forward and reverse scans to the controller 80, the scan provides the controller 80 the degree of accuracy required to align the pixels for generating an accurate computer based image of the specimen 90.

The encoder 101 includes a linear grating scale 102 also mounted to the first drive mechanism 50. The encoder 101 establishes a reference location for the objective lens 52 from a reference point 104 disposed upon the linear grating scale 102.

A first alternative embodiment of the locator 100 is shown in FIG. 3b as a laser range finder 105. Similar to the encoder 101, the laser range finder 105 signals the controller 80 with the location of the first drive mechanism 50 relative to the specimen 90. The laser range finder 105 transmits a laser beam 107 onto a sensor 106 for determining the precise location of the first drive mechanism 50. The sensor 106 includes two embodiments a timing sensor and a position determining sensor. In the case of the timing sensor, the laser range finder 105 transmits the time of travel for the laser beam 107 to the controller 80 for determining the distance of the first drive mechanism 50 from the sensor 106 thereby establishing the location of the first drive mechanism 50. In the case of the position determining sensor, the location the laser beam 107 strikes the sensor 106 is measured and transmitted to the controller 80 for conducting a triangulation calculation thereby determining the location of the first drive mechanism 50.

A third alternative embodiment of the scanner 100 is shown in FIG. 3c as an interferometer 108. The interferometer 108 signals the controller the location of the first drive mechanism 50 as interpolated by the wavelength of the laser beam 107.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. An optical instrument assembly comprising:
a transmitter for emitting a signal onto a specimen;
a detector for detecting a light emitted from the specimen;
a first drive mechanism for varying the position of said signal onto the specimen; and
a locator for determining the location of the first drive mechanism relative to the specimen.

2. An assembly as set forth in claim 1 including a second drive mechanism for varying the position of the specimen relative to said optical signal.

3. An assembly as set forth in claim 2 including a controller for receiving signals from said detector of said emitted optical signal from the specimen.

4. An assembly as set forth in claim 3 wherein said locator comprises an encoder having a linear grating scale and being mounted upon said first drive mechanism, wherein said encoder scans said linear grating scale for determining the location of said first drive mechanism.

5. An assembly as set forth in claim 4 wherein said linear grating scale includes a reference mark for calibrating said encoder.

6. An assembly as set forth in claim 5 wherein said encoder signals said controller with the location of said first drive mechanism relative to said specimen for ensuring the correctness of the computerized specimen image as generated from the emitted signal.

7. An assembly as set forth in claim 3 wherein said locator comprises an interferometer for determining the distance of the first drive mechanism from a reference point.

8. An assembly as set forth in claim 7 wherein said interferometer signals said controller with the location of said first drive mechanism relative to said specimen for ensuring the correctness of the computerized specimen image as generated from the emitted optical signal.

9. An assembly as set forth in claim 8 wherein said locator comprises a laser range finder for determining the distance of the first drive mechanism from a fixed position.

10. An assembly as set forth in claim 9 wherein said laser range finder signals said controller with the location of said first drive mechanism relative to said specimen for ensuring the correctness of the computerized specimen image as generated from the emitted optical signal.

11. An assembly as set forth in claim 10 wherein said laser range finder includes a sensor for receiving a laser beam from said laser.

12. An assembly as set forth in claim 11 wherein said sensor comprises a timing sensor for transmitting the time taken of travel of said laser beam.

13. An assembly as set forth in claim 11 wherein said sensor comprises a position-determining sensor for transmitting the location that said laser beam contacts said sensor.

14. A method of scanning a specimen with an optical instrument comprising the steps of:
directing an optical signal onto a section of the specimen;
scanning fluorescence emitted from the section of the specimen generated by the optical signal;
moving the optical instrument relative to the specimen for scanning fluorescence from different sections of the specimen;
forming a complete scan of the specimen and transmitting the complete scan to a controller; and
determining the location of the optical instrument relative to the specimen for improving the quality of the resulting computerized scan data.

15. A method as set forth in claim 14 including the step of correlating the location of the optical instrument to the fluorescence emitted from each section of the specimen scanned.

16. A method as set forth in claim 15 wherein said step of determining the location of the optical instrument is further defined by scanning a linear grating scale and transmitting the location of the optical instrument on the grating scale to the controller.

17. A method as set forth in claim 14 wherein said step of determining the location of the optical instrument is further defined by determining the time of travel of a laser beam between the optical instrument and a reference point and transmitting the time of travel to the controller.

18. A method as set forth in claim 17 further including the step of calculating the location of the optical instrument from the time of travel of the laser beam between the optical instrument and the reference point.

19. A method as set forth in claim 18 wherein said step of determining the location of the optical instrument is further defined by detecting the spot a laser beam strikes a reference location and transmitting the location to the controller.

20. A method as set forth in claim 19 further including the step of calculating the location of the optical instrument from the spot the laser beam contacted the reference location by triangulation.
